(19) United States
(12) Patent Application Publication
(10) Pub. No.: US 2020/0300219 A1
(43) Pub. Date: Sep. 24, 2020

(54) Hybrid Kite With Integrated Wind Turbine Generator

(71) Applicant: Vandette Carter, New York, NY (US)

(72) Inventor: Vandette Carter, New York, NY (US)

(21) Appl. No.: 16/358,650

(22) Filed: Mar. 19, 2019

(51) Int. Cl. F03D 5/02; B64B 1/50; B64B 1/66; B64B 1/62; B64D 47/08; B64C 31/06; B64D 47/02; G09F 21/06; H01Q 1/08

(52) U.S. Cl. CPC F03D 5/02; B64B 1/50; B64B 1/66; B64B 1/62; H01Q 1/081; B64C 31/06; B64D 47/02; G09F 21/06; B64D 47/08

(57) ABSTRACT

A hybrid kite having an integrated compartment that is inflated with a gas which is lighter than air; the kite is further equipped with a wind turbine generator for the purpose of generating electricity at a high altitude, which can be utilized by the kite or be relayed to the ground for practical use. The kite is anchored in the air as a result of an upward pulling/push force (drag) created by wind, and a combination of buoyancy, to keep the generator/s aloft for an extended period of time beyond 24 hours.

The kite may also serve the purpose of an antenna, to send and receive wireless communication from a base. Moreover the kite can serve as a surveillance vantage point, when equipped with a camera, video camera, microphone and lights, to give an aerial vantage point of a given location.

Numerous other applications for the invention will be realized in conjunction with the primary purpose of providing electricity directly from the generator, which is tethered to the kite, for domestic, industrial & nautical use.

This application claims priority of Prov. Patent App. No. 62/646,359 filed on Mar. 21, 2018. The content of which is recited in part or whole and incorporated within the present non provisional document.

### FIELD OF INVENTION

The invention relates to a means to generate electricity in a portable manner by using the force of the wind acting upon an airborne kite to keep it aloft for extended period of time, without the need to install a permanent wind turbine structure at a stationary location.

### BACKGROUND

There are a handful of renewable energy technologies that are in use throughout the world, for the purpose of generating electricity by way of solar, hydro and wind.

With specific reference to wind turbine power source, very tall towers are required to generate electricity that require wind speed of around 10-15 mph minimum to operate. These wind generators are permanent fixtures at a given location, on and off shore and are often met with mixed reaction when installed in urban areas, as they can be seen as an “eye sore.” Moreover they are very costly to maintain and construct and require a large footprint on land or sea. They also have the disadvantage of not being able to utilize the direction of the wind force efficiently. At at very high wind speeds they may be rendered inoperable.

Nonetheless the tradeoffs have been affordable electricity from these giant wind turbines, within the communities where they are installed, providing a generous amount of renewable for many coastal locations like Atlantic city and Denmark.

Wind studies have revealed that at higher altitude, beyond the height of a traditional wind turbine of 350 feet, the wind speed is appreciably greater and therefore more forceful.

It would be impractical and costly to build a wind turbine higher than its conventional height of ˜335 feet, to take advantage of higher wind velocity. As such, a number of companies have embarked upon using dual kites with algorithms to harness the power of the wind, using the force derived from tension and slack of the two kites, to turn a generator located on the ground, coupled to hydraulic mechanism; a costly process and complex one relatively speaking when compared to the foregoing invention.

In another example, a helium balloon the size of a small truck is deployed with a relatively small wind turbine situated within. The apparatus will require ground harnesses in at least four corners to point the helium balloon in the direction of the wind. Further the balloon will have to be scaled up considerably to produce a similar amount of electricity as a wind turbine—a significant challenge. What is needed is a kite equipped with a generator to perform in a similar manner as a ground base wind turbine generator without the infrastructure requirement. Further a wind turbine that is portable will offer numerous advantages that is not practical with all other wind turbine generators To accomplish this feat, a generator—wind turbine must be attached to the kite, which until now was unheard of.

Since it's not practical to launch a kite with a non-aerodynamic component attached to it, the solution is to launch each component individually, starting with the kite first.

A large kite when subjected to the force of wind, can sustain forces/load exceeding 1,000 lbs across its surface area, with two factors being most important: wind speed and surface area of the kite.

The force exerted on a kite can be determined by the simple formula: F=P×A, whereby P is the pressure and A is the surface area. Henceforth, the larger the surface area of a kite the greater the force and the more weight it can uphold.

As such, 2 feet×4 feet kite will have a surface area of 8 square feet. Air has a density of 0.075 pounds per cubic foot. If a wind speed is 15 mph, the force on an 8 square feet kite can be determined as follow:

F=½×0.075×15²×8×1.0

(67.5 lbs of force will be exerted on this relatively small kite).

A 4×8 feet kite will be able to support an added weight that is less than 25 lbs attached thereto, with a net pulling force that is >70 lbs. When the kite is on the ground, the wind velocity and force acting on the kite is zero. Suffice to say, it will require more energy and technique to launch a kite with a large payload attached.

As demonstrated mathematically, the situation is quite different & remarkable when the kite is in the air first, subjected to a modest wind speed of 15 mph or greater, which is very common at coastal region. The kite can then support a weight in the air for considerable period of time when an upward pulling force of over 100 lbs is acting upon it. This phenomenon would allow for an object other than the kite to hang from the sky in accordance with Newton's third law. Better yet, when the wind speed reaches 21 mph/sec., then an artificial G force effect can be exerted upon the kite. At such wind speed and beyond, an artificial gravitational point can be created in the sky, to anchor an object such as a generator thereto.

In the event of wind speed falling less than 10 mph, causing the kite and payload to be overcome by gravity, the kite is equipped with compartments, containing a gas that's lighter than air, helium or hydrogen. The air filled compartment will allow for a gradual descend of the kite and payload to be recovered on the ground.

The kite with wind turbine attached thereto has the advantage of maximizing the direction the wind and its velocity since the kite will naturally follow the direction of the wind. The turbine can be in the same plane as the kite thereby maximizing the confrontation with wind or made to turn at any angle when attached below the anchoring cable of the kite as will be illustrated in the forgoing.

### DESCRIPTION OF THE DRAWING

FIG. 1 is perspective view of a kite in the deployed position in the air, with two turbine generators attached to its cable.

FIG. 2. Is a perspective view of the kite and generators attached below its main cable, 13.

### DETAIL DESCRIPTION OF EMBODIMENT

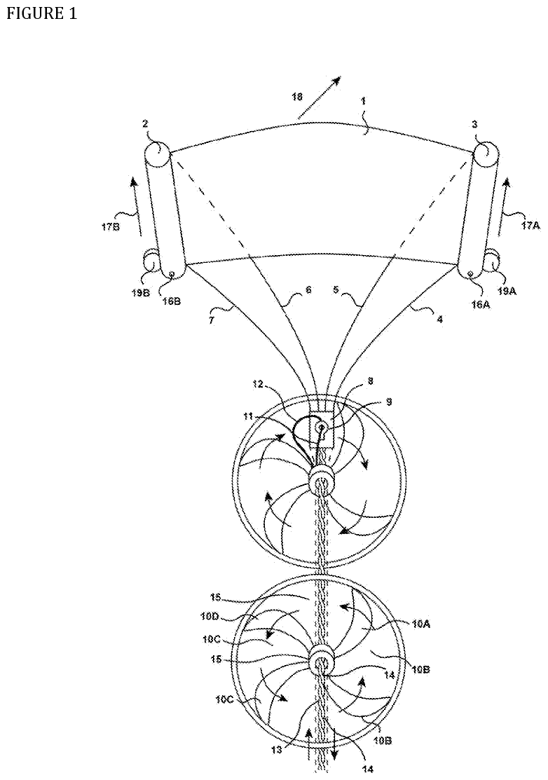

With reference to FIG. 1, a kite having a dimension of 8 feet×4 feet (may be larger or smaller) is shown deployed with a wind force 18 being exerted on the inner surface of the kite 1. An upward buoyancy, 17a and 17b is provided by a gas filled compartments 2 & 3, having helium or hydrogen therein (or a combination of gases in sub compartments within 2 and 3). In the unlikely event the wind velocity falls below a threshold to keep the generators airborne, the helium/hydrogen inflated compartment will permit gradual fall of the wind turbines, limiting or minimizing damage.

A four-point cable 4, 5, 6 & 7 secure the kite to the handler on the ground via a common main cable 13.

A focal anchoring harness 8, forms a receiving (mating member) which is secured over the four cables 4-7. A pulley harness 9 is attached to the anchoring member 8 to draw up the turbine towards the kite after its deployed. A pulley cable 12 is shown which is made to pass through the core of the wind turbine to facilitate its upward or downward movement, operated from the ground level.

Lights 19A & 19B may be attached to provide illumination, warning or decoration, using power derived directly or indirectly from a generator tethered to the kite. A pair of weights 16A and 16B may be added for stabilization of the kite.

Once the kite is in its full deployed position with optimum wind speed to support a weight that is less than the pulling force of the kite, a generator is then attached over the common cable 13 and advanced upward by way of a loop-pulley system 8 and 12.

A cable 12 traverse through the generator and parallel to main cable 13; it then loops around a stationary receiving pulley member 12 and return via the opening of the generator 15.

An anchoring latch associated with securing member 8 is provided to receive the generator at its opening 15 when pulled upward by the pulley-anchoring pair.

The generator 11 and 14 are then fastened individually or consecutively over graduating anchoring harnesses so as to fix the generator firmly in place there upon.

The generator has a set of fan blades 10A, 10B, 10C and 10D, oriented in such a way to rotate at maximum speed when subjected to the velocity of the wind, directed by the movement of the kite, facing the direction of the wind.

An electric current is produced when the fan blades of the generator rotates which is then directed to the ground via conducting wire 14, that traverses via the opening 15 of the generator.

In summary the generator is pulled up towards the kite along main cable 13 via the which may also serve as an electrical conducting cord/cable to a load or battery suited on the ground. The electrical connection to the ground from the generator may be engineered in a manner well known in the art.

The invention is described in the simplest of manner and may be engineered in such as way to maintain extended time in the air and equipped with any number of sensors to monitor its performance. These advancements have been considered and provide a platform for further innovation to be improved upon the kite with generators attached thereto after deployment. It is contemplated that the generators can also be deployed with the kite at the same time when lifted off the ground by a drone/s for example, to a height where the kite can be acted upon by the wind.

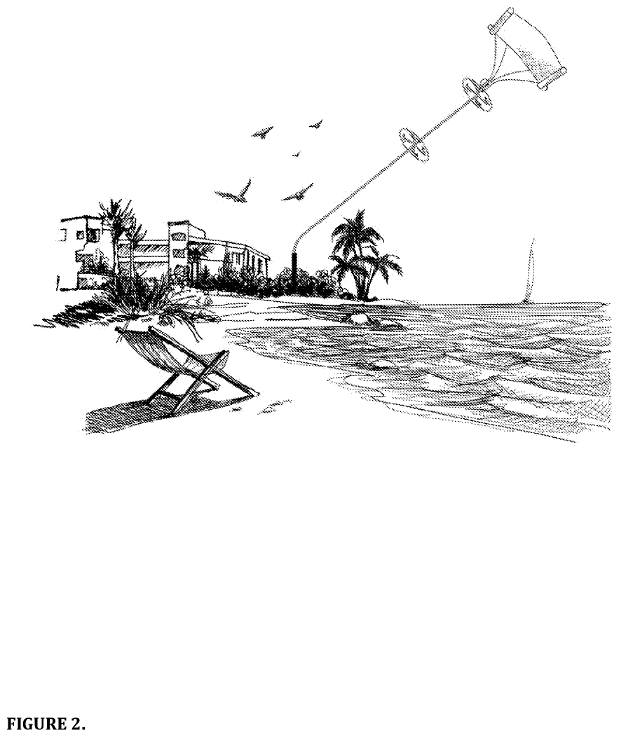

Also multiple generators may be added to the cable 13 (two are shown in FIG. 1 and FIG. 2) and are designed to spin in opposite direction in order to prevent “drift” which may occur by the momentum of the turning blades of the generators. With at least 2 generators spaced apart evenly, stability of the cable 13 will be realized as the opposite drift phenomenon of the two generators, spinning in opposite direction, will neutralize the relative force of each other.

As in FIG. 2, the generators can be placed below the main cable 13 as shown and made to swivel with the direction of the wind or remain fixed.

For surveillance purposes, camera or video cameras can be attached to the kite and obtain its electricity from the generators attached thereto.

The height of the kite and cable may also function as antenna for communication means to a satellite or radio or cell phone tower.

In nautical applications and disaster relief, the invention can provide emergency power, lighting, surveillance and communications using renewable energy (wind) in a portable manner. The aforementioned are a brief summary of the numerous applications and purpose the invention will serve for every day use and in extreme circumstances.

1. Claims is directed to a hybrid kite having an least one integrated compartment that is inflated with a gas which is lighter than air; the kite is coupled to at least one wind turbine generator which is designed to be anchored to the kite after it is deployed, using a pulley harness and mating member.

2. The kite as in claim 1 which may perform the function of an antenna, to send and receive wireless communication signals to from a satellite, radio or cell tower.

3. A kite as in claim 1 to serve as a surveillance vantage point, when equipped with a camera, video camera, microphone and a light, to give an aerial vantage point of a given location.

4. A kite as in claim 1 to be used in disaster relief efforts on land and sea.

5. A kite as in claim 1 may have one or more generators attached thereto and engineered in such a way to face the wind with the movement of the kite, allowing maximum electricity output.

6. The kite of claim 1 may have advertisement material written thereto, to be viewed during the night or day, when illuminated.
